(19) United States
(12) Patent Application Publication
(10) Pub. No.: US 2006/0115295 A1
(43) Pub. Date: Jun. 1, 2006

(54) Image forming unit and color image forming apparatus having the same

(75) Inventors: Dong-Ju Kang, Anyang-si (KR); Yong-Su Kim, Yongin-si (KR); In-Sub Yoo, Seoul (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/283,736

(22) Filed: Nov. 22, 2005

(30) Foreign Application Priority Data
Nov. 26, 2004 (KR) 2004-97906

(51) Int. Cl. G03G 21/18

(52) U.S. Cl. 399/111

(57) ABSTRACT

Provided are an image forming unit and a color image forming apparatus having the image forming unit. The image forming unit includes an intermediate transfer belt, a plurality of belt roller shafts formed at both ends of each of a plurality of belt rollers allowing the intermediate transfer belt to perform an endless orbiting motion, a plurality of photosensitive drums lined up along a rotational direction of the intermediate transfer belt, a plurality of photosensitive drum shafts formed at both ends of each of the plurality of photosensitive drums, and a developing frame comprising a plurality of holes supporting the plurality of belt roller shafts and the plurality of photosensitive drum shafts.

### CROSS-REFERENCE TO RELATED APPLICATIONS

This application claims the benefit of Korean Patent Application No. 2004-97906 filed Nov. 26, 2004, the entire disclosure of which is hereby incorporated by reference.

### BACKGROUND OF THE INVENTION

1. Field of the Invention

The present invention relates to an image forming unit and a color image forming apparatus having the same. More particularly, the present invention relates to an image forming unit including photosensitive drums and an intermediate transfer belt forming a single body and a color image forming apparatus having the same.

2. Description of the Related Art

In general, a color image forming apparatus includes an exposing unit, an image forming unit, a transfer unit, a sheet feeding unit, a fixing unit, a sheet discharging unit, and a main body frame. The exposing unit emits a laser beam corresponding to printing data. The image forming unit forms a predetermined image corresponding to the printing data onto a photosensitive medium. The transfer unit transfers the predetermined image formed by the image forming unit to a printing medium. The sheet feeding unit feeds the printing medium to the transfer unit. The fixing unit fixes the transferred image onto the printing medium. The sheet discharging unit discharges the printing medium onto which the transferred image is fixed to the outside. The main body frame supports the exposing unit, the image forming unit, the transfer unit, the sheet feeding unit, the fixing unit, and the sheet discharging unit.

The image forming unit includes four photosensitive drums on which yellow (Y), magenta (M), cyan (C), and black (B) color images are formed and an intermediate transfer belt to and/or on which the Y, M, C, and B color images are transferred and overlapped so as to form a complete color image. Photosensitive drum shafts protrude from both ends of each of the photosensitive drums and are rotatably supported by sub-frames. Each of the sub-frames is fixed to a main body frame so as to install the four photosensitive drums in a line along a rotation direction of the intermediate transfer belt. The intermediate transfer belt is installed so as to perform an endless orbiting motion via a drive belt roller and a passive belt roller. The drive belt roller and the passive belt roller are rotatably supported by an intermediate frame, and the intermediate frame is fixed to the main body frame. Also, charging units and developing units are integrally or separately installed around the sub-frame supporting the photosensitive drum shafts so that the photosensitive drum shafts rotate. The charging unit charges the photosensitive drums, and the developing unit develops electrostatic latent images formed on the photosensitive drums as a specific color image. Four exposing units are installed to emit laser beams for forming electrostatic latent images corresponding to the printing data on the four photosensitive drums.

Thus, the four exposing units emit the laser beams to form the electrostatic latent images corresponding to the printing data on the photosensitive drums.

The electrostatic latent images formed on the photosensitive drums pass through the developing units so as to be developed as specific color visible images and then are transferred to the intermediate transfer belt. Here, since the intermediate transfer belt performs the endless orbiting motion via the drive belt roller and the passive belt roller, images formed on the four photosensitive drums installed in a line at predetermined distances along the rotation direction of the intermediate transfer belt are transferred to and/or overlapped on the intermediate transfer belt so as to form the complete color image. The color image formed on the intermediate transfer belt is transferred from the transfer unit to the printing medium, passing through the fixing unit so as to be fixed onto the printing medium, and is discharged via the sheet discharging unit to the outside.

However, to obtain a high-quality color image from the image forming unit, when the images formed on the four photosensitive drums are sequentially transferred to and overlapped on the intermediate transfer belt, the images must accurately coincide with previously transferred images. Free movements between the intermediate transfer belt and the four photosensitive drums must be relatively small to increase an accuracy of overlapping transferred images. However, in the conventional image forming unit, the four photosensitive drums are respectively assembled into a separate sub-frame and then installed on the main body frame. Also, the drive belt roller and the passive belt roller driving the intermediate transfer belt are assembled into a separate intermediate frame and then installed on the main body frame separately from the sub-frames. Thus, in the conventional image forming unit, many parts are interposed between the four photosensitive drums and the intermediate transfer belt. Thus, the free movements between the four photosensitive drums and the intermediate transfer belt may vary greatly. FIG. 9 illustrates an example of measuring free movements among the four photosensitive drums and the intermediate transfer belt in the conventional image forming unit.

As described above, if the free movements between the photosensitive drums and the intermediate transfer belt constituting the image forming unit are great, color images may not be accurately overlapped. If an accuracy of overlapping the color images is poor, a high-quality printed material may not be obtained.

Accordingly, there is a need for an improved image forming unit which minimizes free movements between an intermediate transfer belt and a plurality of photosensitive drums to improve performance of the unit.

### SUMMARY OF THE INVENTION

An aspect of the present invention is to solve at least the above problems and/or disadvantages and to provide at least the advantages described below. Accordingly, an aspect of the present invention is to provide an image forming unit which minimizes free movements between an intermediate transfer belt and a plurality of photosensitive drums so as to improve an overlapping accuracy of color images.

Another aspect of the present general inventive concept is to provide a color image forming apparatus including an image forming unit which minimizes free movements between an intermediate transfer belt and a plurality of photosensitive drums so as to improve an overlapping accuracy of color images.

According to an aspect of the present invention, there is provided an image forming unit including an intermediate transfer belt, a plurality of belt roller shafts formed at both ends of each of a plurality of belt rollers allowing the intermediate transfer belt to perform an endless orbiting motion, a plurality of photosensitive drums lined up along a rotational direction of the intermediate transfer belt, a plurality of photosensitive drum shafts formed at both ends of each of the plurality of photosensitive drums, and a developing frame comprising a plurality of holes supporting the plurality of belt roller shafts and the plurality of photosensitive drum shafts.

The developing frame may further include position determination parts. The position determination parts are preferably a plurality of pins.

The developing frame may be formed of a substantially rigid material.

According to another aspect of the present invention, there is provided an image forming unit including an intermediate transfer belt, a plurality of belt roller shafts formed at both ends of each of a plurality of belt rollers allowing the intermediate transfer belt to perform an endless orbiting motion, a plurality of photosensitive drums lined up along a rotation direction of the intermediate transfer belt, a plurality of photosensitive drum shafts formed at both ends of each of the plurality of photosensitive drums, a first bracket comprising a plurality of holes supporting an end of each of the plurality of belt roller shafts and an end of each of the photosensitive drums shafts, and a second bracket comprising a plurality of holes supporting an other end of each of the plurality of belt roller shafts and an other end of each of the photosensitive drums shafts.

The first bracket may further include a plurality of pins formed toward a direction along which the end of the each of the plurality of photosensitive drum shafts protrudes.

The second bracket may include a plurality of pin holes for determining positions.

The first and second brackets may be formed of a substantially rigid material.

According to still another aspect of the present invention, there is provided a color image forming apparatus transferring images formed on a plurality of photosensitive drums to an intermediate transfer belt to form a color image, including a plurality of belt roller shafts formed at both ends of each of a plurality of belt rollers allowing the intermediate transfer belt to perform an endless orbiting motion, a plurality of photosensitive drum shafts formed at both ends of each of a plurality of photosensitive drums, a first bracket including a plurality of holes supporting an end of each of the plurality of belt roller shafts and an end of each of the photosensitive drums shafts and first position determination parts, a second bracket including a plurality of holes supporting an other end of each of the plurality of belt roller shafts and an other of each of the photosensitive drums shafts and second position determination parts, and a main body frame comprising third and fourth position determination parts corresponding to the first and second position determination parts.

The first position determination parts may be a plurality of pins formed toward a direction along which an end of each of the plurality of photosensitive drum shafts protrudes.

The second position determination parts may be a plurality of pin holes.

If an image forming unit according to an embodiment of the present invention is applied, free movements between the intermediate transfer belt and a plurality of photosensitive drums are minimized, and therefore, the accuracy of overlapping the color images can increase.

If a color image forming device applying an image forming unit according to an embodiment of the present invention is applied, free movements between the intermediate transfer belt and the plurality of photosensitive drums are minimized so that a high-quality printed material with increased accuracy of overlapping color images can be obtained.

Other objects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other objects, features, and advantages of certain embodiments of the present invention will be more apparent from the following description taken in conjunction with the accompanying drawings, in which:

FIG. 1 is a perspective view of an image forming unit according to an exemplary embodiment of the present invention;

FIG. 2 is a perspective view illustrating a front side of the image forming unit shown in FIG. 1 from which a second bracket is separated;

FIG. 3 is a perspective view illustrating a rear side of the image forming unit shown in FIG. 1;

FIG. 4 is a perspective view illustrating the front side of the image forming unit shown in FIG. 1 into which a cover is assembled;

FIG. 5 is a partial cross-sectional view of the image forming unit, shown in FIG. 1, mounted on a main body frame;

FIG. 6 is a perspective view of an image forming unit according to another exemplary embodiment of the present invention;

FIG. 7 is a schematic cross-sectional view of a color image forming apparatus including an image forming unit according to an exemplary embodiment of the present invention;

FIG. 8 is a graph illustrating free movements between an intermediate transfer belt and a plurality of photosensitive drum shafts in an image forming unit according to an exemplary embodiment of the present invention; and

FIG. 9 is a graph illustrating movements between an intermediate transfer belt and a plurality of photosensitive drum shafts in a conventional image forming unit.

Throughout the drawings, the same drawing reference numerals will be understood to refer to the same elements, features, and structures.

### DETAILED DESCRIPTION OF EXEMPLARY EMBODIMENTS

The matters defined in the description such as a detailed construction and elements are provided to assist in a comprehensive understanding of the embodiments of the invention. Accordingly, those of ordinary skill in the art will recognize that various changes and modifications of the embodiments described herein can be made without departing from the scope and spirit of the invention. Also, descriptions of well-known functions and constructions are omitted for clarity and conciseness.

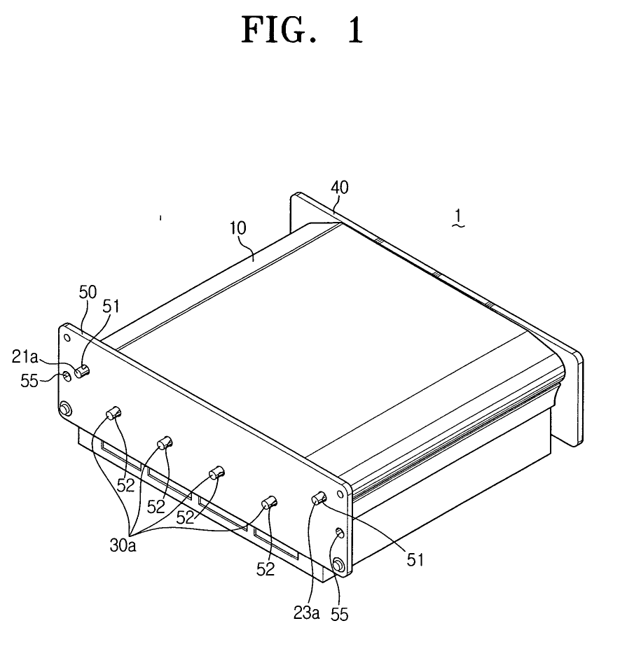

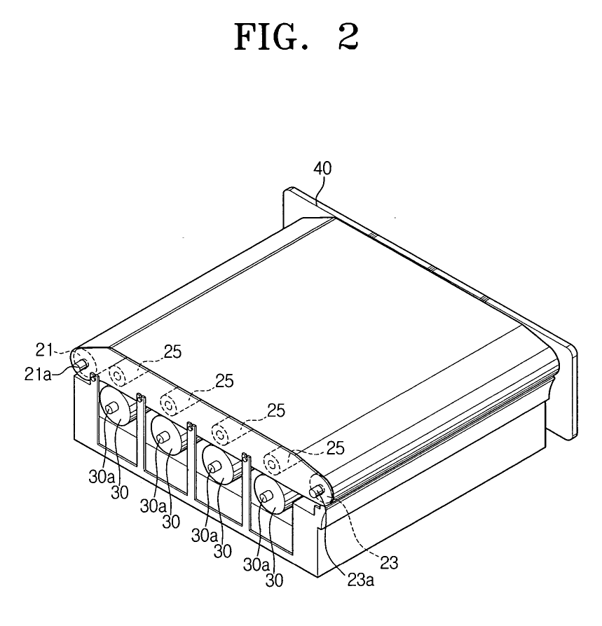

Referring to FIGS. 1 through 4, an image forming unit 1 according to an exemplary embodiment of the present invention includes an intermediate transfer belt 10, a plurality of belt rollers 21 and 23, a plurality of photosensitive drums 30, first and second brackets 40 and 50, and a cover 60.

The intermediate transfer belt 10 performs an endless orbiting motion via the plurality of belt rollers 21 and 23. Images are sequentially transferred and/or overlapped from the plurality of photosensitive drums 30, and are preferably installed under the intermediate transfer belt 10 so as to form a complete color image.

The plurality of belt rollers 21 and 23 are drive belt rollers which receive power from a drive source (not shown) to rotate. Additionally, a passive belt roller supports the endless orbiting motion of the intermediate transfer belt 10 and rotates via movement of the intermediate transfer belt 10. Belt roller shafts 21a and 21b protrude from both ends of the drive belt roller 21, and belt roller shafts 23a and 23b protrude from both ends of the passive belt roller 23. A plurality of transfer backup rollers 25 may be installed in positions opposite to the plurality of photosensitive drums 30 between the drive belt roller 21 and the passive belt roller 23 inside the intermediate transfer belt 10.

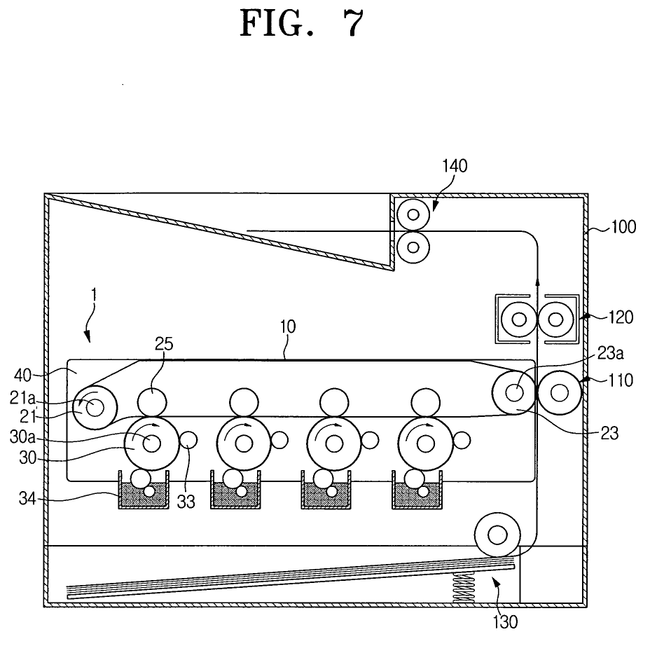

The plurality of photosensitive drums 30 are lined up under the intermediate transfer belt 10 at predetermined distances along a rotational direction of the intermediate transfer belt 10. In the present exemplary embodiment, four photosensitive drums on which Y, M, C, and B color images are respectively formed are used to form a complete color image. Photosensitive drum shafts 30a and 30b protrude from both ends of each of the plurality of photosensitive drums 30. As shown in FIG. 7, charging units 33 and developing units 34 are installed around the photosensitive drums 30. The charging units 33 charge the photosensitive drums 30 with predetermined voltages, and the developing units 34 develop electrostatic latent images formed on the photosensitive drums 30 with specific colors. Laser beams emitted from exposing units (not shown) are arranged between the charging units 33 and the developing units 23 so as to form the electrostatic latent images on the photosensitive drums 30.

The first and second brackets 40 and 50, respectively, include a plurality of roller shaft holes 41 and 51 which rotatably support the belt roller shafts 21a, 21b, 23a, and 23b of the plurality of belt rollers 21 and 23. A plurality of drum shaft holes 42 and 52 rotatably support the photosensitive drum shafts 30a and 30b of the plurality of photosensitive drums 30. In the present exemplary embodiment, the first and second brackets 40 and 50, respectively, include two roller shaft holes 41 and 51 for supporting the belt roller shafts 21a and 21b of the drive belt roller 21. Consequently, the belt roller shafts 21a, 21b, 23a and 23b rotate so that the four photosensitive drum shafts 30a and 30b rotate within four drum shaft holes 42 and 52. The first and second brackets 40 and 50 may be formed of a substantially rigid material so as not to deform due to rotations of the intermediate transfer belt 10 and the photosensitive drums 30. When the belt roller shafts 21a, 21b, 23a, and 23b are supported by the roller shaft holes 41 and 51, bushings or bearings may be interposed between the roller shaft holes 41 and 51 and the belt roller shafts 21a, 21b, 23a, and 23b. Also, even when the photosensitive drum shafts 30a and 30b are supported by the drum shaft holes 42 and 52, bushings or bearings may be interposed between the photosensitive drum shafts 30a and 30b and the drum shaft holes 42 and 52.

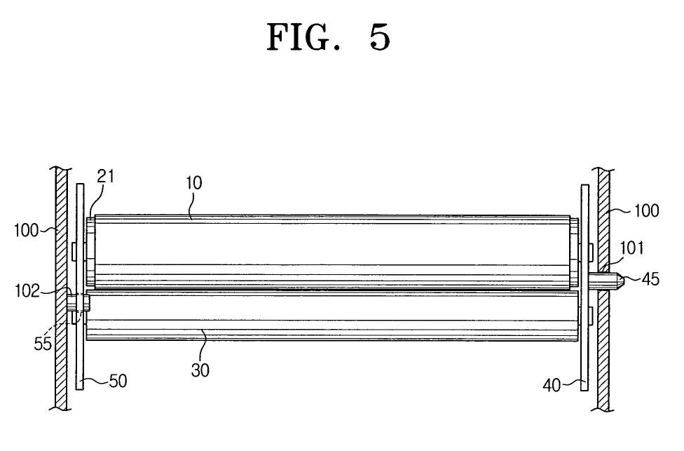

The first and second brackets 40 and 50, respectively, include first and second position determination parts 45 and 55 to determine a position in which the image forming unit 1 is mounted on the main body frame 100 as shown in FIG. 7. Third and fourth position determination parts 101 and 102, corresponding to the first and second position determination parts 45 and 55, are formed on the main body frame 100 as shown in FIG. 5. Various suitable position determination methods may be used for the first, second, third and fourth position determination parts 45, 55, 101 and 102. In the present exemplary embodiment, a position determination method using pins and holes is used for the first, second, third, and fourth position determination parts 45, 55, 101, and 102. In other words, a plurality of pins are formed as the first position determination parts 45 at the first bracket 40, and a plurality of pin holes corresponding to the plurality of pins of the first position determination parts 45 are formed as the third position determination parts 101 formed in a position corresponding to the main body frame 100 into which the first bracket 40 is assembled. A plurality of pin holes are formed as the second position determination parts 55 and the fourth position determination parts 102 of the main body frame 100 supporting the second bracket 50 are formed as a plurality of pins corresponding to the plurality of pin holes of the second position determination parts 55 at the second bracket 50. Here, a number of the plurality of pins and a number of the plurality of pin holes may be each “2.” The allocation of pins and pin holes to the first, second, third, and fourth position determination parts 45, 55, 101, and 102 is only one exemplary embodiment, but, other suitable combinations of pins and pin holes may be variously allocated to the first, second, third, and fourth position determination parts 45, 55, 101, and 102. If necessary, the first position determination parts 45 may be formed as a pin and a pin hole, and the third position determination parts 101 may be formed as combinations of a pin and a pin hole.

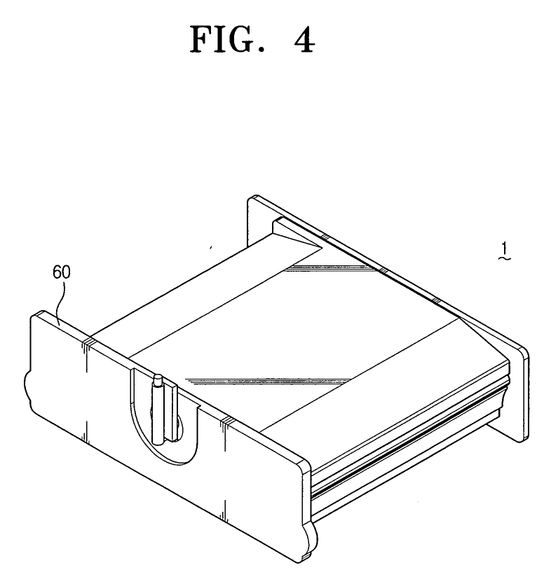

The cover 60 is installed so as to prevent the intermediate transfer belt 10, installed between the first and second brackets 40 and 50, from being contaminated. FIG. 4 shows the image forming unit 1 to which the cover 60 is attached.

The operation of an image forming unit having the above-described structure will now be described.

The photosensitive drums 30 receive power from drive units (not shown) to rotate. If the photosensitive drums 30 rotate, surfaces of the photosensitive drums 30 are charged, and electrostatic latent images are formed on the surfaces of the photosensitive drums 30 and developed with developing solutions. Consequently, a predetermined color image is formed. Specific color images are formed on the photosensitive drums 30 and are then transferred to and overlapped on the intermediate transfer belt 10. The intermediate transfer belt performs an endless orbiting motion via the drive belt roller 21 and the passive belt roller 23 so as to form a complete color image. Here, the drive belt roller 21 is rotated by a motor (not shown). However, movements between the photosensitive drums 30 and the intermediate transfer belt 10, such as, position variations of the photosensitive drums 30 and intermediate transfer belt 10, preferably are minimize so as to accurately transfer images formed on the photosensitive drums 30 to the intermediate transfer belt 10 and overlap images formed on the photosensitive drums 30 on the intermediate transfer belt 10.

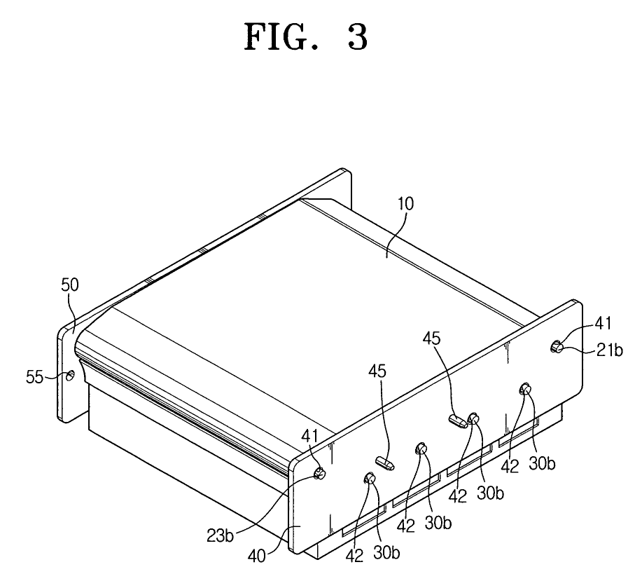

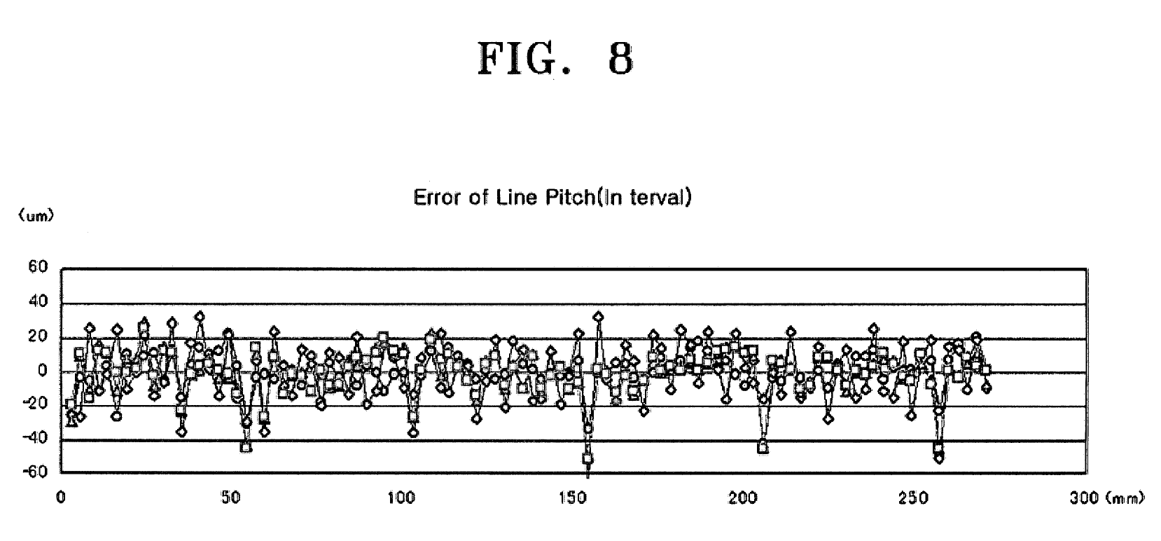

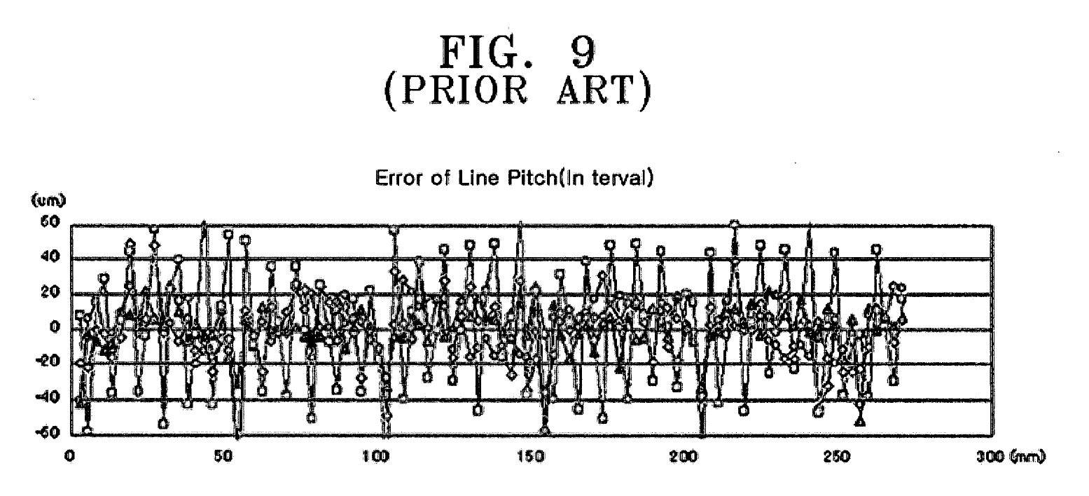

For this purpose, as shown in FIG. 3, the photosensitive drum shafts 30b formed at an end of each of the four photosensitive drums 30 and the belt roller shafts 21b and 23b formed at ends of the belt rollers 21 and 23 are configured to engage with the four drum shaft holes 42 and the two roller shaft holes 41 formed on the first bracket 40, respectively. Also, as shown in FIG. 1, the photosensitive drum shafts 30a formed at the other ends of the four photosensitive drums 30 and the belt roller shafts 21a and 23a formed at the other ends of the drive belt roller 21 and the passive belt roller 23 are configured to engage with the four drum shaft holes 52 and the two roller shaft holes 51 formed on the second bracket 50, respectively. In addition, the first and second brackets 40 and 50 are formed of a substantially rigid material that does not deform due to the rotations of the plurality of photosensitive drums 30 and the drive belt roller 21. Thus, in a case where the first and second brackets 40 and 50 are fixed to the main body frame 100, as shown in FIG. 5, a position of the end of each of the four photosensitive drums 30 with respect to the intermediate transfer belt 10 and position relations among the four photosensitive drums 30 are determined by gaps between the plurality of roller shaft holes 41 and 51 and the plurality of drum shaft holes 42 and 52. Even in a case where the intermediate transfer belt 10 performs the endless orbiting motion and the plurality of photosensitive drums 30 rotate, an end position of the four photosensitive drums 30, with respect to the intermediate transfer belt 10, and the position relations among the four photosensitive drums 30 are maintained within a predetermined range. The free movements between the intermediate transfer belt 10 and the plurality of photosensitive drums 30 are determined by a manufacturing tolerance between the plurality of belt roller shafts 21, 21b, 23a, and 23b and the roller shaft holes 41 and 51 and a manufacturing tolerance between the plurality of photosensitive drum shafts 30a and 30b and the drum shaft holes 42 and 52. FIG. 8 is a graph illustrating the free movements of the plurality of photosensitive drums shafts 30a and 30b of the image forming unit 1 according to the exemplary embodiments of the present invention. In other words, FIG. 8 shows the free movements of the plurality of photosensitive drum shafts 30a and 30b when a printing medium is transferred at a predetermined distance. Compared with the free movements of the plurality of photosensitive drum shafts in the conventional image forming unit shown in FIG. 9, the free movements of the photosensitive drum shafts 30a and 30b are greatly reduced. If the free movements of the photosensitive drum shafts 30a and 30b are reduced as described above, an overlapping accuracy of color images transferred and overlapped from the plurality of photosensitive drums 30 to the intermediate transfer belt 10 is improved. Thus, a color printed material having good color overlapping can be obtained.

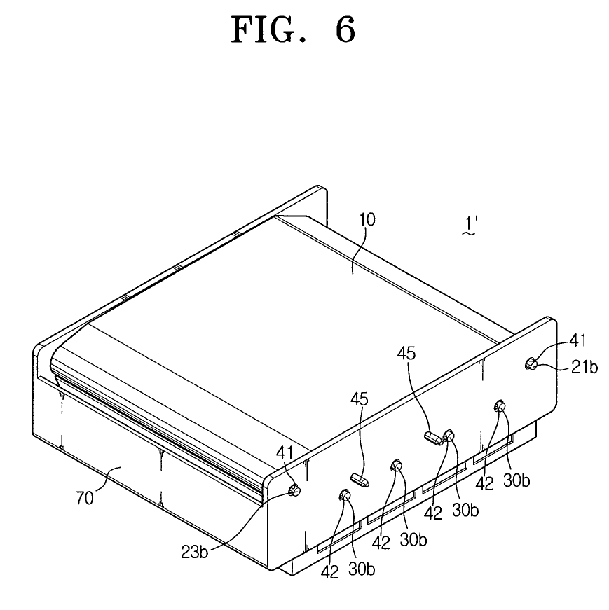

FIG. 6 is a schematic perspective view of an image forming unit according to another exemplary embodiment of the present invention. An image forming unit 1′ according to the present embodiment is the same as the image forming unit 1 according to the previous embodiment except that the first and second brackets 40 and 50 form a single body, such as, a developing frame 70. In the image forming unit 1′, the developing frame 70 is formed in a rectangular box shape and thus is assembled as an additional unit so as to be mounted at the main body frame 100. Thus, the work required to mount the image forming unit 1′ on the main body frame 100 in the present embodiment is simpler than that in the previous embodiment. The other elements of the image forming unit 1′ and their operations are the same as those of the image forming unit 1, and thus their detailed description will be omitted herein for clarity and conciseness.

FIG. 7 is a schematic cross-sectional view of a color image forming apparatus including an image forming unit in accordance with the exemplary embodiments of the present invention.

Referring to FIG. 7, the image forming apparatus includes an image forming unit 1, a transfer unit 110, a fixing unit 120, a sheet feeding unit 130, a sheet discharging unit 140, and a main body frame 100.

Referring to FIGS. 1, 3, 5, and 7, the image forming unit 1 is mounted in a predetermined position on the main body frame 100 and includes an intermediate transfer belt part, the four photosensitive drums 30, and the first and second brackets 40 and 50.

The intermediate transfer belt part includes the intermediate transfer belt 10, the drive belt roller 21, and the passive belt roller 23. The intermediate transfer belt 10 performs the endless orbiting motion via the drive belt roller 21 and the passive belt roller 23, and images are sequentially transferred to and overlapped on the intermediate transfer belt 10 from the four photosensitive drums 30 installed thereunder. As a result, a complete color image is formed. The drive belt roller 21 receives power from a drive source (not shown) to rotate, and the passive belt roller 23 supports the endless orbiting motion of the intermediate transfer belt 10 and rotates by movements of the intermediate transfer belt 10. The belt roller shafts 21a, 21b, 23a, and 23b protrude from both ends of each of the drive belt roller 21 and the passive belt roller 23. The four transfer backup rollers 25 are installed in the positions opposite to the four photosensitive drums 30 between the drive belt roller 21 and the passive belt roller 23, preferably, inside the intermediate transfer belt 10.

The four photosensitive drums 30 are lined up at predetermined distances under the intermediate transfer belt 10 along the rotational direction of the intermediate transfer belt 10, and Y, M, C, and B color images are respectively formed on the four photosensitive drums 30. The photosensitive drum shafts 30a and 30b protrude from the both ends of each of the photosensitive drums 30. The charging units 33 and the developing units 34 are installed around the photosensitive drums 30. The charging units 33 charge the photosensitive drums 30 with predetermined voltages, and the developing units 34 develop electrostatic latent images formed on the photosensitive drums 30 with specific colors. Laser beams emitted from the exposing units (not shown) are arranged between the charging units 33 and the developing units 34 so as to form the electrostatic latent images on the photosensitive drums 30.

The first and second brackets 40 and 50, respectively, include the two roller shaft holes 41, 51 supporting the belt roller shafts 21a and 21b of the drive belt roller 21 and the belt roller shafts 23a and 23b of the passive belt roller 23, so, the belt roller shafts 21a, 21b, 23a, and 23b rotate and the four drum shaft holes 42, 52 support the four photosensitive drum shafts 30a and 30b so that the four photosensitive drum shafts 30a and 30b rotate. The first and second brackets 40 and 50 are rigidly formed and do not deform via the rotations of the intermediate transfer belt 10 and the four photosensitive drums 30. The bushings are interposed between the roller shaft holes 41 and 51 and the belt roller shafts 21a, 21b, 23a, and 23b. Bushings are also interposed between the drum shaft holes 42 and 52 and the photosensitive drum shafts 30a and 30b.

The first and second position determination parts 45 and 55 are formed on the first and second brackets 40 and 50 so as to determine a position in which the image forming unit 1 is to be mounted at the main body frame 100. The third and fourth position determination parts 101 and 102 correspond to the first and second position determination parts 45 and 55 and are formed on the main body frame 100. In the present embodiment, the first position determination parts 45 are formed as two pins in a direction along which ends of the photosensitive drum shafts 30b protrude from an outer surface of the first bracket 40 as shown in FIG. 3, and the third position determination parts 101 are formed as two pin holes corresponding to the two pins of the first position determination parts 45 in a corresponding position of the main body frame 100 into which the first bracket 40 is assembled as shown in FIG. 5. The two holes are formed as the second position determination parts 55 on the second bracket 50, and the fourth position determination parts 102 of the main body frame 100 supporting the second bracket 50 are formed as two pins corresponding to the two pin holes of the second position determination parts 55.

The image forming unit 1 includes the above-described elements assembled into one sub-assembly and may be mounted as a single body with the main body frame 100 or may be separated from the main body frame 100. Here, a position of the main body frame 100 in which the image forming unit 1 is to be mounted is determined by the third and fourth position determination parts 101 and 102 formed on the main body frame 100 and the first and second position determination parts 45 and 55 formed on the image forming unit 1.

The transfer unit 110 transfers a color image from the intermediate transfer belt 10 of the image forming unit 1 to a printing medium and is installed in a position opposite to the passive belt roller 23 of the intermediate transfer belt part.

The fixing unit 120 fixes the transferred color image onto the printing medium, and the sheet discharging unit 140 discharges the printing medium onto which the color image is completely fixed to the outside. The sheet feeding unit 130 separates loaded printing media one by one and transfers the separated printing media to the transfer unit 110.

A printing process performed using the color image forming apparatus having the above-described structure will now be described.

The four photosensitive drums 30 are charged with the predetermined voltages via the charging units 33. If the photosensitive drums 30 rotate, the laser beams emitted from the four exposing units (not shown) are respectively arranged on the four photosensitive drums 30 so that the electrostatic latent images are formed on portions of the photosensitive drums 30 charged by the exposing units, the laser beams corresponds to the printing data. If the four photosensitive drums 30 continuously rotate, the electrostatic latent images are respectively developed as the specific color images via the developing units 34 are then transferred to the intermediate transfer belt 10. Here, the specific color images are sequentially transferred to and overlapped on the intermediate transfer belt 10 from the four photosensitive drums 30 lined up at the predetermined distances. As a result, the complete color image is formed on the intermediate transfer belt 10. Here, the belt roller shafts 21a, 21b, 23a, and 23b of the drive belt roller 21 and the passive belt roller 23 rotate the intermediate transfer belt 10 and the four photosensitive drum shafts 30a and 30b of the four photosensitive drums 30 are all supported by the first and second brackets 40 and 50. Thus, the free movements between the intermediate transfer belt 10 and the four photosensitive drums 30 are minimized in a process for transferring the images.

The color image formed on the intermediate transfer belt 10 is transferred to the printing medium via the transfer unit 110. The color image transferred to the printing medium is fixed onto the printing medium through the fixing unit 120 and discharged outside a main body via the sheet discharging unit 140.

While the invention has been shown and described with reference to certain embodiments thereof, it will be understood by those skilled in the art that various changes in form and details may be made therein without departing from the spirit and scope of the invention as defined by the appended claims.

What is claimed is:

1. An image forming unit comprising:
an intermediate transfer belt;
a plurality of belt roller shafts formed at both ends of each of a plurality of belt rollers allowing the intermediate transfer belt to perform an endless orbiting motion;
a plurality of photosensitive drums lined up along a rotational direction of the intermediate transfer belt;
a plurality of photosensitive drum shafts formed at both ends of each of the plurality of photosensitive drums; and
an integrally connected developing frame comprising a plurality of holes supporting the plurality of belt roller shafts and the plurality of photosensitive drum shafts.

2. The image forming unit of claim 1, wherein the developing frame further comprises position determination parts.

3. The image forming unit of claim 2, wherein the position determination parts are a plurality of pins.

4. The image forming unit of claim 1, wherein the developing frame is formed of a substantially rigid material.

5. An image forming unit comprising:
an intermediate transfer belt;
a plurality of belt roller shafts formed at both ends of each of a plurality of belt rollers allowing the intermediate transfer belt to perform an endless orbiting motion;
a plurality of photosensitive drums lined up along a rotational direction of the intermediate transfer belt;
a plurality of photosensitive drum shafts formed at both ends of each of the plurality of photosensitive drums;
a first bracket comprising a plurality of holes supporting an end of each of the plurality of belt roller shafts and an end of each of the photosensitive drums shafts; and
a second bracket comprising a plurality of holes supporting an other end of each of the plurality of belt roller shafts and an other end of each of the photosensitive drums shafts.

6. The image forming unit of claim 5, wherein the first bracket further comprises:
a plurality of pins formed toward a direction along which the end of the each of the plurality of photosensitive drum shafts protrudes.

7. The image forming unit of claim 5, wherein the second bracket comprises a plurality of pin holes for determining positions.

8. The image forming unit of claim 5, wherein the first and second brackets are formed of a substantially rigid material.

9. A color image forming apparatus transferring images formed on a plurality of photosensitive drums to an intermediate transfer belt to form a color image, comprising:
a plurality of belt roller shafts formed at both ends of each of a plurality of belt rollers allowing the intermediate transfer belt to perform an endless orbiting motion;
a plurality of photosensitive drum shafts formed at both ends of each of a plurality of photosensitive drums;
a first bracket comprising a plurality of holes supporting an end of each of the plurality of belt roller shafts and an end of each of the photosensitive drums shafts and first position determination parts;
a second bracket comprising a plurality of holes supporting an other end of each of the plurality of belt roller shafts and an other end of each of the photosensitive drums shafts and second position determination parts; and
a main body frame comprising third and fourth position determination parts corresponding to the first and second position determination parts.

10. The color image forming apparatus of claim 9, wherein the first position determination parts are a plurality of pins formed toward a direction along which an end of each of the plurality of photosensitive drum shafts protrudes.

11. The color image forming apparatus of claim 9, wherein the second position determination parts are a plurality of pin holes.

12. The color image forming apparatus of claim 9, wherein the first and second brackets are formed of a substantially rigid material.

13. The color image forming apparatus of claim 9, wherein the first and second brackets are integrally connected.
